(19) United States
(12) Patent Application Publication
(10) Pub. No.: US 2021/0322801 A1
(43) Pub. Date: Oct. 21, 2021

(54) WASHABLE AND REUSABLE FACE MASK WITH REPLACEABLE FILTER

(71) Applicant: BILIO LLC, Berkeley, CA (US)

(72) Inventors: Harry William Smith, IV, San Anselmo, CA (US); Nicholas Andrew Smith, Sausalito, CA (US); Neil Tagner, Taylorsville, NC (US); Jason R. Wilkins, Taylorsville, NC (US)

(21) Appl. No.: 17/236,611

(22) Filed: Apr. 21, 2021

Related U.S. Application Data
(63) Continuation-in-part of application No. 29/745,890, filed on Aug. 10, 2020.
Application No. 29/745,890 is a continuation-in-part of application No. 29/745,891, filed on Aug. 10, 2020.
(60) Provisional application No. 63/013,494, filed on Apr. 21, 2020.
(60) Provisional application No. 63/014,016, filed on Apr. 22, 2020.
(60) Provisional application No. 63/160,651, filed on Mar. 12, 2021.

(51) Int. Cl. A62B 18/02; A62B 18/08; A62B 7/10; A62B 23/02; A41D 13/11; B01D 39/08; B01D 39/16; B32B 5/02; B32B 5/26

(52) U.S. Cl. CPC A62B 18/025; B32B 2571/00; A62B 7/10; A62B 23/025; A41D 13/1138; B01D 39/083; B01D 39/086; B01D 39/1623; B32B 5/022; B32B 5/026; B32B 5/279; B32B 5/267; A41D 2500/10; B01D 2239/0681; B01D 2239/0442; B01D 2239/0609; B01D 2239/0618; B01D 2239/0627; B32B 2250/20; B32B 2262/0276; B32B 2262/103; B32B 2262/152; B32B 2307/7145; B32B 2307/724; A62B 18/084

(57) ABSTRACT

A face mask include a bulbous area that reduces contact between the wearer and the mask, with the inner surface texture and material adapted to be comfortable to the wearer. The bulbous area may be equipped with a filter retained by slots at the edge of the bulbous area, with the inner surface texture and material of the filter also adapted to be comfortable to the wearer. The mask may be knit with seamless transitions between wearer-contacting surfaces and the bulbous area, which enhance the comfort of the mask. The mask may include silvered yarns for antimicrobial properties. Furthermore, the bulbous area increases the effective surface area of the mask on both inhalation and exhalation, unlike pleats that collapse on inhalation.

### CROSS REFERENCE TO RELATED APPLICATIONS

This application claims priority to: U.S. Provisional Patent Application No. 63/013,494, entitled “Washable And Reusable Face Mask With Zonally Engineered Antimicrobial Yarns,” filed Apr. 21, 2020″; U.S. Provisional Patent Application No. 63/014,016, entitled “Washable And Reusable Face Mask With Zonally Engineered Antimicrobial Yarns,” filed Apr. 22, 2020″; and U.S. Provisional Patent Application No. 63/160,651, entitled “Washable And Reusable Face Mask With Replaceable Filter,” filed Mar. 12, 2021; and this application is a continuation-in-part of: U.S. Design patent application No. 29/745,890, entitled “Face Mask,” filed Aug. 10, 2020; and a continuation-in-part of U.S. Design patent application No. 29/745,891, entitled “Face Mask,” filed Aug. 10, 2020, each of which is incorporated by reference in its entirety.

### BACKGROUND

Personal protective equipment (PPE) in the form of face masks are typically fabricated from sheets of paper or fabric, and are typically disposable. Sheets of filter paper, e.g., “single use” non-woven filters, and fabric are typically tailored or pleated to conform to a face. The traditional die-cut and sew approach can create waste in the discard, and uncomfortable seams in the final product. Furthermore, even if a mask is re-used, the mask itself may be contaminated from, e.g., being touched by the wearer. And an additional undesirable feature of many masks is that they irritate the wearer, causing a condition coming to be known as “maskne.”

Thus, what is needed is a mask that reduces waste, is re-usable, may reduce contamination through its construction or washability, and is less irritating to the wearer.

### BRIEF DESCRIPTION OF THE DRAWINGS

The embodiments are illustrated by way of example and not limitation in the accompanying drawings, in which like references indicate similar elements, and in which:

FIG. 1 is a front view of an embodiment of a mask;

FIG. 2 is a rear view of the embodiment of a mask of FIG. 1;

FIG. 3 is a left side view of the embodiment of a mask of FIG. 1;

FIG. 4 is a top view of the embodiment of a mask of FIG. 1;

FIG. 5 is a bottom view of the embodiment of a mask of FIG. 1;

FIG. 6 is an isometric front view of an embodiment of a mask;

FIG. 7 is a rear view of details of the embodiment of a mask of FIG. 1;

FIG. 8 is a perspective view of an element of an embodiment of a mask;

FIG. 9 is a top view of an element of an embodiment of a mask;

FIG. 10 is a left side view of an embodiment of a mask;

FIG. 11 is a rear view of the embodiment of a mask of FIG. 10;

FIG. 12 is a rear view of an embodiment of a mask;

FIG. 13 is a rear right perspective view of the embodiment of a mask of FIG. 12;

FIG. 14 is a front view of an embodiment of a mask;

FIG. 15 is a rear perspective view of a detail of the embodiment of a mask of FIG. 14;

FIG. 16 is a rear perspective view of the embodiment of a mask of FIG. 14;

FIG. 17 is a top perspective view of the embodiment of a mask of FIG. 14;

FIG. 18 is a rear view of the embodiment of a mask of FIG. 14;

FIG. 19 is a rear view of an element from the embodiment of a mask of FIG. 14;

FIG. 20 is an assembly view of the element from FIG. 19; and

FIG. 21 is a schematic illustrating the wearing of an embodiment of a mask.

### DETAILED DESCRIPTION

Embodiments described within disclose a protective mask with zonal engineered knitting that uses facial sizing data to inform the design so that the final product conforms to the wearer's face. The zonal knitting allows the mask to be form fitting without creating the waste that a mask sewn from sheets of fabric or paper might create. The zonal knitting provides for a more comfortable mask by eliminating sewn seams. The zonal knitting allows the yarns of the knit to be customized for particular areas of the mask, so that the resultant knit may transition in in composition and function from one area of the mask to the next according to the needs of the area. Using the process of zonal engineered knitting, embodiments of the mask may be sized to fit a broad range of profiles and fit with a more ergonomically sensitive design that hugs the facial contours more efficiently than the traditional die-cut and sew approach to mask fabrication. Such zonal engineering may be accomplished using, e.g., a flatbed knitting machine such as a model available from Stoll by Karl Mayer (www.stoll.com).

To reduce the potential for contamination, embodiments of the mask may be washable, or may be constructed with an antimicrobial silver yarn, or both. For example, the silver yarn may include X-STATIC®, which is a silver yarn that is EPA registered to resist microorganism growth available from Noble Biomaterials, Inc. Silver yarns release positively charged silver ions in the presence of moisture, which prohibits microorganism growth, controls odor, and eliminates bacteria on contact.

In embodiments, the silver yarn may be blended with polyester to create a blend that is breathable, form-fitting, and comfortable against the skin, which prevents “maskne.” Furthermore, the polyester may be recycled, which makes the final product more sustainable than if virgin plastics had been used. One such blend, which includes both silver yarns and recycled polyester (SilverKiss™, from Bilio LLC), has antimicrobial properties and may be re-washed over 250 times without compromising performance. This material has been tested to have a Bacterial Filtration Efficiency (BFE) of approximately 90% (mean=89.9%, n=5) measuring with a particle size of 0.27 microns and a Particle Filtration Efficiency (PFE) of approximately 85% (mean=84.4%, n=5) measuring with a particle size of 0.1 microns.

Thus, embodiments may be washable and reusable, “knit-to-shape”, with zero or little waste, and knit with recycled materials that require no post-processing. As a result, such embodiments help to keep “single use” non-woven filters available for N95 mask production and out of landfills.

In some embodiments, the knit may be designed to create a “heather” appearance. “Heather” refers to interwoven yarns of different colors, which when knit together, produce flecks of alternating color. The pre-dyed yarns are blended together to give a particular look. In some embodiments, heather is used to mix multiple shades of gray, or gray with another color to produce a muted shade. The term “heather” may also be used to describe the fabric made from heathered yarns.

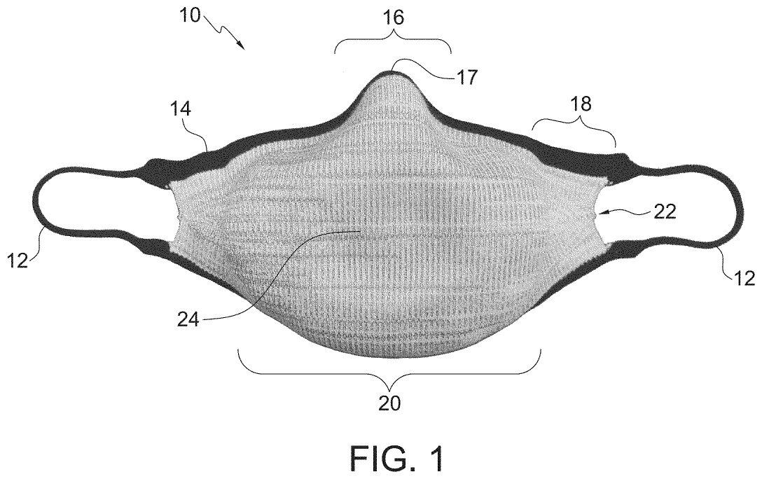

FIG. 1 is a front view of an embodiment of a mask 10. In FIG. 1, mask 10 includes ear loops 12, which connect to a border 14. Upper and lower sections of border 14 bound transition to a surface 24, which includes a includes a cheek area 18 and a facial area 20. Facial area 20 itself includes a nose area 16. Cheek area 18 connects between facial area 20 and ear loop 12. Each cheek area 18 includes a dart 22. A bridge 17 is formed in border 14 and nose area 16 to accommodate the wearer's nose.

Dart 22 is knit within cheek area 18, which provides for the knit to transition from the flat cheek area 18 to the bulbous facial area 20. Dart 22 also enhances the structure and rigidity and reduces the elasticity of cheek area 18 with respect to facial area 20. Dart 22 thus provides a backbone of sorts to cheek area 18. With dart 22 in place, cheek area 18 is found to lay flatter against a wearer's cheek on exhale, which improves the filtering properties of mask 10 because it reduces the volume of breath escaping from mask 10 unfiltered. Thus, cheek areas 18 in combination with border 14 cooperate to form a seal that, on exhale particularly, forces the wearer's breath through the filtering knit material of surface 24.

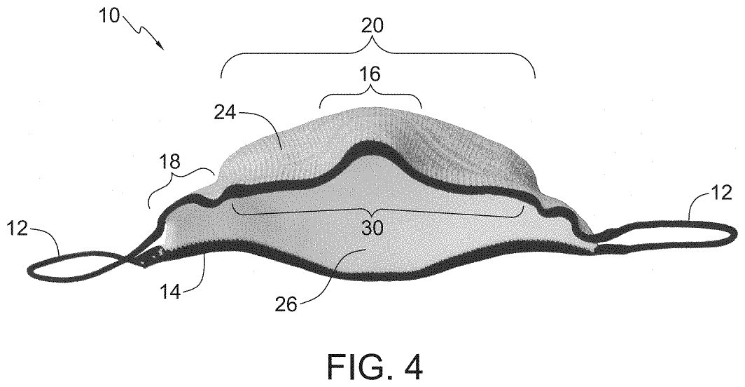

In an embodiment, dart 22 may be constructed as follows: 1) mask 10 is knit in a pattern with a notch at a left and right side of surface 24; 2) the edges of a notch are brought together edge-to-edge; 3) the edges are then knit together so that there is no cut seam or edge on the interior or exterior cheek area 18, or elsewhere in facial area 20. This construction provides for part of the 3D shape of cheek area 18 seen in, e.g., FIG. 4.

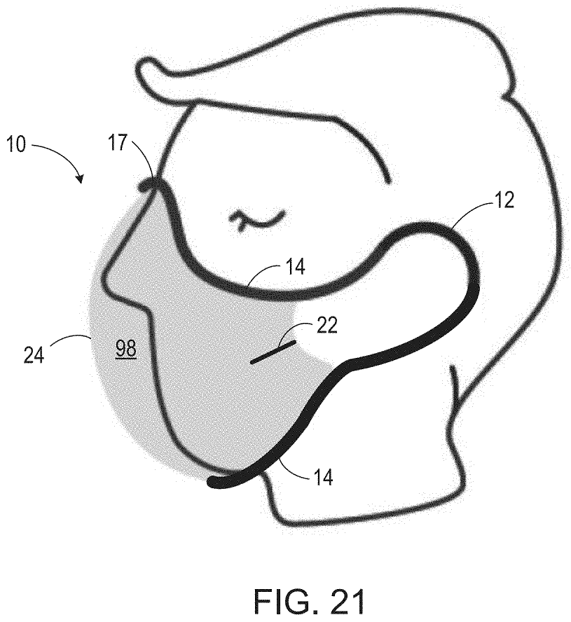

In the embodiment, the material of facial area 20 may be knit from a silver yarn that is blended with a polyester yarn to create a blend that is breathable, form-fitting, and comfortable against the skin, with the knit and the silver yarn providing the properties discussed above. In embodiments, the material of facial area 20 may be “heathered” for appearance. Border 14 may be stretchable to conform to facial contours and transitions into ear loops 12, which surround the wearer's ears to hold mask 10 to the wearer. Ear loops 12 may be knit with relatively more elastic than border 16, so that ear loops 12 deform relatively more than border 16 when mask 10 is fitted to a wearer. In an embodiment, ear loops 12 may be discontinuous, e.g., loops 12 may be strings that extend from both the upper and lower border sections and that are tied or otherwise connected together behind the ear to retain mask 10 to the wearer. Bridge 17 is knit into nose region 16 to provide space for the wearer's nose within facial area 20. As shown, bridge 17, nose region 16 and facial area 20 are contoured to create a bulbous area so that, when mask 10 is worn, much of the mask material of those sections does not contact the wearer. A feature of the bulbous area is that it allows for, on exhale, a wearer's breath to be distributed across a relatively large percentage of mask 10, e.g., more or less the entirety of facial region 20. By providing for a non-contact area over an extensive part of the mask, embodiments of mask 10 may be more comfortable to wear than masks with more contact area. Also, by providing for such an extensive, non-contact area and distributing the wearer's breath over the extensive, non-contact area of surface 24, mask 10 may increase the duration it may be worn before becoming saturated with moisture from the wearer's breath, and may be more efficient in filtering the wearer's breath. FIG. 21 is a schematic illustrating the wearing of an embodiment of a mask. In FIG. 21, surface 24 is shown to be bulbous and to provide a space 98 between the wearer and mask 10. Space 98 is similarly distributed laterally across the wearer's face so that space 98 may extend laterally for the majority of facial area 20. Thus, the exhaled breath of the wearer may be filtered by the knit fabric of the bulbous section of facial area 20.

In an embodiment, mask 10 may be zonally engineered such that mask 10 is entirely knit, i.e., the transitions from ear loops 12 to border 14, from border 14 to face 20, and from face 20 to side flap 18 are knit and without a sewn seam. By eliminating sewn seams, the zonally-engineered embodiment may further improve comfort and fit. And by eliminating the traditional die-cut and sew construction method, the zonally-engineered embodiment may reduce waste.

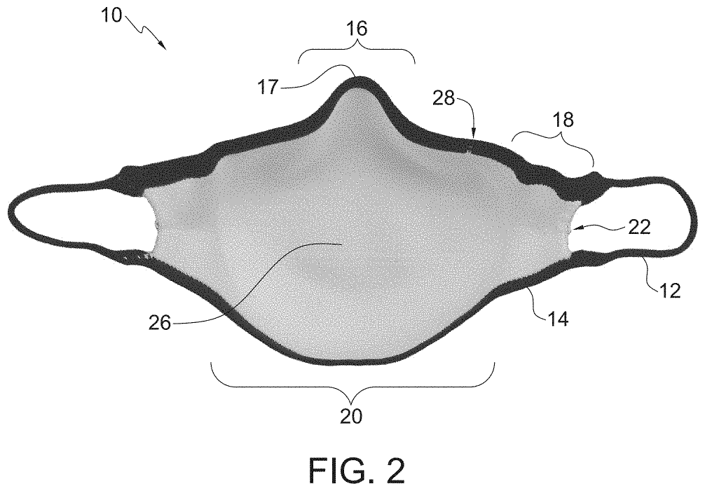

FIG. 2 is a rear view of the embodiment of mask 10. In FIG. 2, mask 10 is shown to have an inner surface 26 that is different in appearance from the outer side of surface 24. This difference in appearance illustrates a benefit of the zonal engineered knit—the knit may be altered to have different properties in different places. For example, in an embodiment, inner surface 26 is engineered to be higher in composition of the polyester, which is significantly more comfortable against the wearer's skin than the silvered yarn. In contrast, in the embodiment, the outer side of surface 24 is engineered to be higher in composition of the silvered yam, which puts the antimicrobial properties of the silvered yarn on the exterior surface of mask 10 where they may be more beneficial. In the embodiment of FIG. 2, the exterior, “heathered” look of the mask is actually not coarser than the interior. The interior/exterior are the same fundamental knit structure, but different yarns are used. On the exterior, in addition to the silvered yarn, the “poly” yarn is a “spun” poly which creates a more uneven look. In an embodiment, the silvered yarn is excluded from inner surface 26.

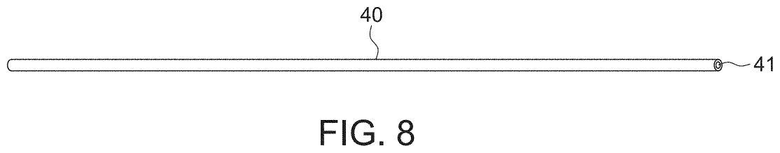

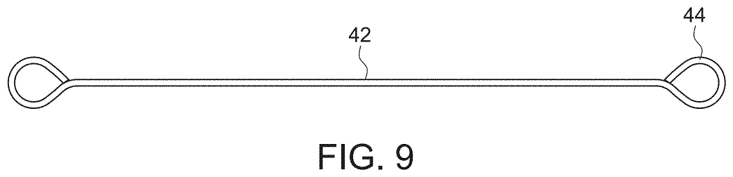

FIG. 2 illustrates that border 14 includes an access port 28. Access port 28 is knit into border 16 and provides for the insertion or removal of a deformable batten (40, FIG. 8, 42, FIG. 9) within border 14. Being knit into border 16, access port 28 does not irritate the user in the way that, e.g., an eyelet might. Deformable batten 40 spans bridge 17 and runs between cheek areas 18. Access port 28 allows the deformable batten to be removed before mask 10 is washed. In addition, port 28 allows for the replacement of the deformable batten should it become damaged from extended use, which enhances the sustainability of mask 10.

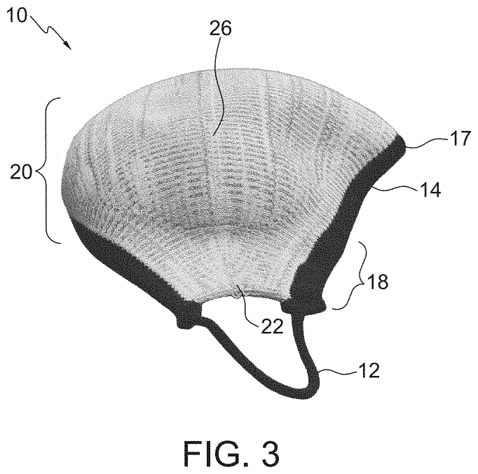

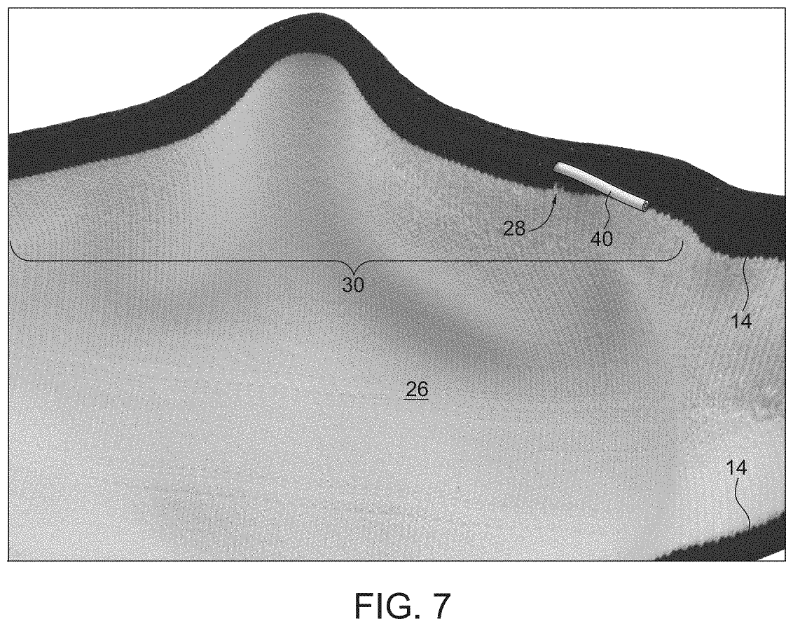

FIG. 3 is a left side view of the embodiment of mask 10. FIG. 3 further illustrates the bulbous nature of facial area 20. In contrast, cheek area 18 is shown to be relatively flat and is assisted in remaining so by dart 22. FIG. 3 also further illustrates the seal formed by the connection of cheek area 18 between the upper and lower sections of border 14. While FIG. 3 shows cheek area 18 and the upper and lower sections of border 14 adapting to a flat surface, they are similarly able to conform to a wearer's facial features as shown in FIG. 21. Bridge 17, within the upper section of border 14, is created by a combination of zonal engineering, in which extra material is knit to accommodate the wearer's nose, and by the addition of a deformable batten 40, 42 (40 (FIG. 7), 42 (FIG. 8)) within border 14. The deformable batten may be deformed to the extent necessary to adapt bridge 17 to follow the contours of the wearer's nose and cheek.

FIG. 4 is a top view of the embodiment of mask 10. In FIG. 4, a region 30 indicates the location a tube knit within border 14. The tube of region 30 may contain the deformable batten 40, 42. As will be shown, the deformable batten is initially straight and is deformed to fit the wearer after being positioned within region 30. FIG. 4 further illustrates the relative difference in appearance between the outer side of surface 24 and inner surface 26 that is made possible by zonal engineering knitting.

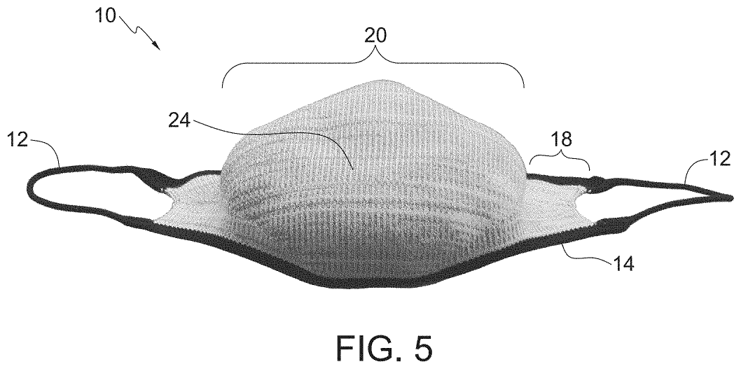

FIG. 5 is a bottom view of the embodiment of mask 10. FIG. 5 further illustrates the bulbous nature of facial area 20 and flat nature of cheek areas 18. Cheek areas 18 and borders 14 combine to form a foundation of sorts from which the bulbous facial area 20 expands. In this manner, mask 10 provides a close and adjustable fit to the wearer, and a space 98 (FIG. 21) into which the wearer's breath may be dispersed. By being dispersed into space 98, rather than directly onto inner surface 26 opposite a wearer's nose or mouth, mask 10 distributes the wearer's breath over a larger surface area, thus filtering the breath by a greater portion of inner surface 26. This may increase the length of time mask 10 may be worn without becoming saturated with moisture. Space 98 may also increase the length of time mask 10 may be worn comfortably by reducing the area of mask 10 in contact with the wearer.

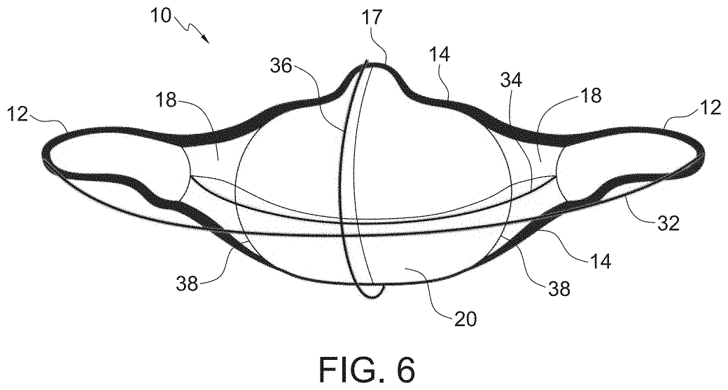

FIG. 6 is an isometric front diagram of the embodiment of mask 10. FIG. 6 includes a transition line 38 between cheek area 18 and facial area 20. Transition line 38 indicates where zonal engineering may dictate where the knitting technique that provides for the flat nature of cheek 18 changes to a technique that provides for the bulbous nature of facial area 20. Also, while FIG. 6 refers to mask 10, it may be used to provide exemplary adult dimensions, applicable to any embodiment of this specification, in which an overall width 32 may range from 13″ to 14″, a width of facial area 20 plus cheek areas 18 may range from 7″ to 8.5″, and a height of facial region 20 may range from 5.5″ to 6″.

FIG. 7 is a rear view of details of the embodiment of mask 10. In FIG. 7, deformable batten 40 is shown to protrude from access port 28 of the upper section of border 14. Batten 40 may be fully inserted into border 14 by grasping border 14 near bridge 17 and stretching border 14 so that access port 28 rises up and engulfs the exposed end of batten 40, after which border 14 may be relaxed and batten 40 guided within border 14. In the embodiment, deformable batten 40 may be an insulated copper wire 41 (FIG. 8). However, in other embodiments (FIG. 9), a deformable batten 42 (FIG. 8) may be a bare copper wire with a loop 44 at each end. In other embodiments, a deformable batten may terminate at each end with a coil (not shown). Both the coil and loop 44 create a blunt end with a relatively expanded surface area that resists being forced through the knit material of border 14, which reduces the chance of the wire poking through the material and either sliding out or scratching the user.

Embodiments of the deformable batten contribute significantly to the filtering function of the mask. By adjusting the deformable batten to the contours of the wearer's face, the mask creates a significantly snugger seal around the wearer's nose bridge and cheeks. An added benefit is that, by improving the seal about the wearer's nose and cheeks, the deformable batten also improves the seal about the wearer's chin by reducing the tendency of the mask to droop. In other words, the use of the deformable batten boosts the filtering efficiency of the mask.

The deformable batten also benefits a wearer of glasses by reducing fogging. After the mask is positioned, the deformable batten is made to conform to the wearer's contours by being pressed firmly over and around the bridge and against the cheeks. Glasses may then be worn in place—on top of the wire. The deformable batten establishes a seal that directs exhalation downward, which will reduce or eliminate fogging.

Embodiments of deformable battens 40, 42 may be removed from the mask by grasping both the deformable batten 40, 42 and border 14 at the end of the deformable batten that is furthest from access port 28. The other hand is then used to grasp border 14 between access port 28 and the nearest ear loop. Stretching the mask between the hands will cause the unrestrained end of the deformable batten 40, 42 to travel to the access port 28 and pop through, allowing the deformable batten to be removed.

In an embodiment, mask 10 may have the following composition.

TABLE 1

| Yarns Position | Yarn Description |
|---|---|
| Yarn Type Main Body Front (outer | 20/2 Spun Poly |
| surface)/Back (inner surface 26): | |
| Yarn Type Plate Front (outer | 70 SC 1/70/34 Z Nylon Covered |
| surface)/Back (inner surface 26): | Spandex |
| Yarn Type Tuck: | KC 70 20/7 Nylon Covered |
| | Spandex |
| Yarn Type Border 14/Straps 12 | 70 SC 1/70/34 Z Nylon Covered |
| | Spandex |
| Silver X-Static “MIX” Front (outer | 30 den 7 filament X-Static (Noble) |
| surface) | |

TABLE 2

| Material Composition | Percentage |
|---|---|
| Poly 50% | 50% |
| Nylon 34% | 34% |
| Spandex 9% | 9% |
| Silver 7% | 7% |

In Table 1: “body” refers to the inner or outer side of surface 24; “plate” or “plating” is a knit method of running two yarns together but keeping one yarn behind the other; “tuck,” otherwise known as a “spacer knit,” refers to the yarn structure connecting the two surfaces of a knit. In an embodiment, both the “plate” and the “tuck” are within the interior of the knit material such that neither comes in contact with either a wearer or a holder of the mask. In an embodiment, both the “plate” and the “tuck” may be within the interior of the knit material such that neither initially comes in contact with either a wearer or a holder of the mask, but the plate and tuck may shift over time, such that the plate or tuck may rise to the exterior surface. In other words, in an embodiment, the single “main” layer of knit material of surface 24 of mask 10 may include two “body” layers that contact a holder or wearer, two “plate” layers on the inside of the knit material that do not contact the wearer or holder (at least initially), and a spacer knit that joins the outer body/plate combination to the inner body/plate combination. Thus, in embodiments, a single “main” knit layer, e.g., surface 24, may include sub layers of different types of yarns, e.g., of a body, plating, and spacer knit.

The discussion of mask 10 and the associated elements applies equally to the following embodiments unless specified otherwise. Similarly, the discussion of the following embodiments and their associated elements applies to mask 10 unless specified otherwise.

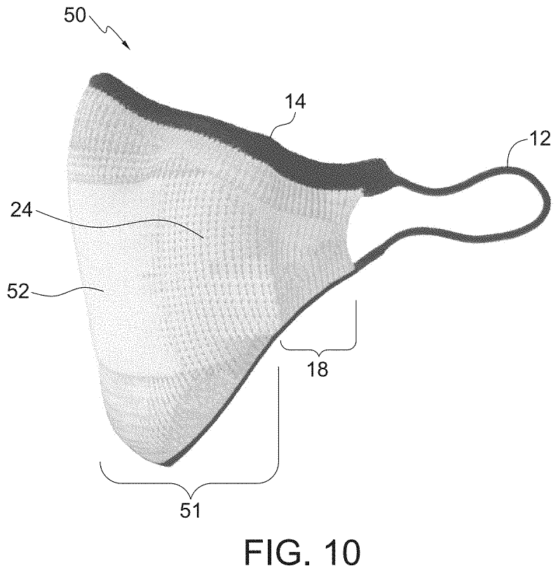

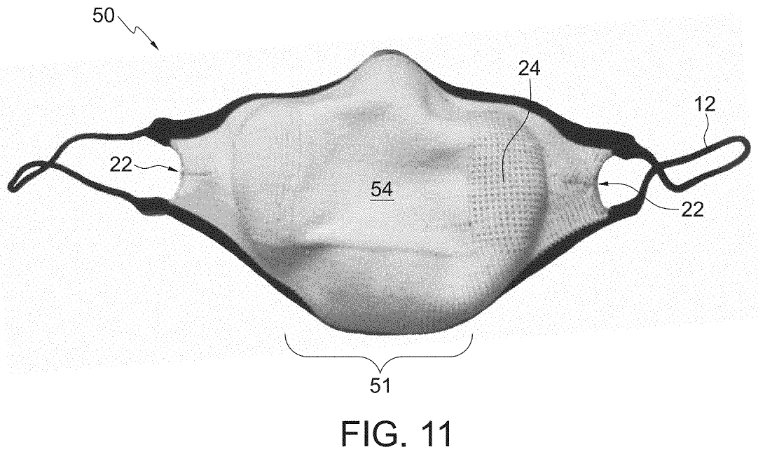

FIG. 10 is a left side view of an embodiment of a mask 50. In FIG. 10, mask 50 includes, in a facial area 51 and a textured area 52 in which the texture is different from the remainder of the outer side of surface 24. Textured area 52 indicates an area in which the composition of the yarns has been selected to include more of the silvered yarns. Thus, textured area 52 has an enhanced antimicrobial properties. FIG. 11 is a rear view of the embodiment of mask 50. In FIG. 11, the rear of facial area 51 is shown to include a textured area 54, which corresponds to textured area 52 on the front of mask 50. Mask 50 is otherwise similar to mask 10.

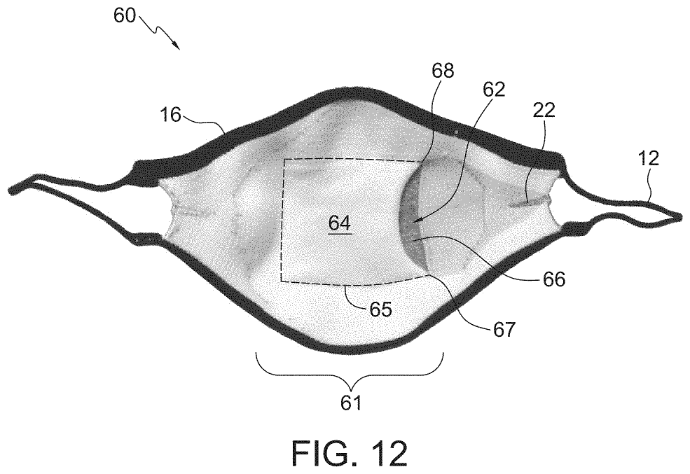

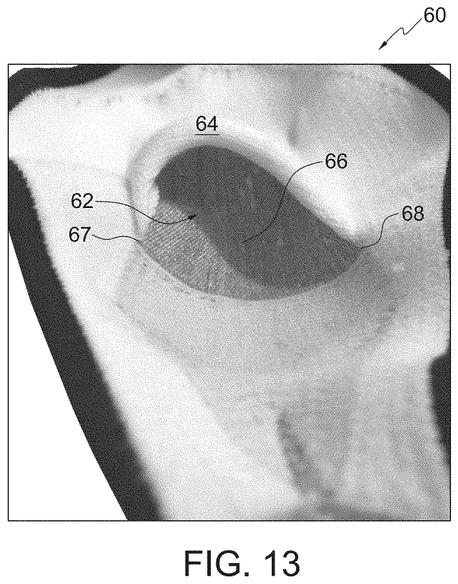

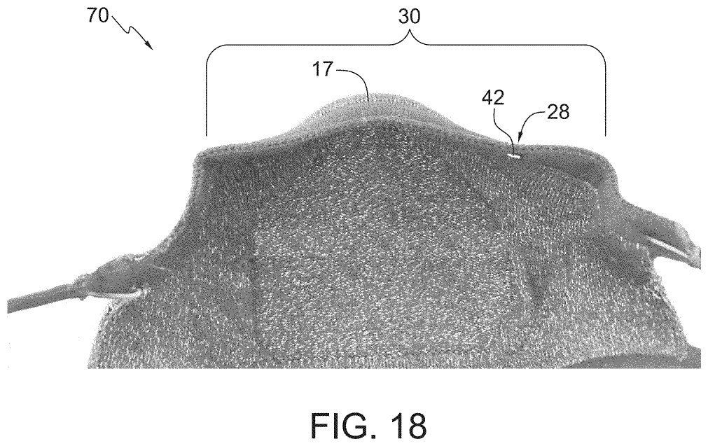

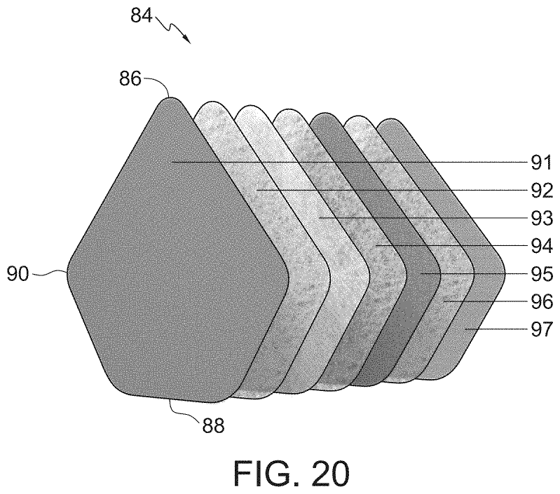

FIG. 12 is a front view of the embodiment of a mask 60. In FIG. 12, mask 60 includes, within a facial area 61, a pocket 62. Pocket 62, the extent of which is indicated by an imaginary dotted line 65, is formed by an inner layer 64 that is separated from an outer layer 66. Inner layer 64 has the same appearance as the remainder of the inner face of mask 60. However, with inner layer 64 being separate and distinct from outer layer 66 within the perimeter 64, mask 60 has a two-layer structure within perimeter 64 and a single layer structure otherwise. Transition points 67, 68 indicate visible areas where mask 60 transitions from a single layer to the two-layers of pocket 62. The composition of the inner layer of mask 60 is similar to the inner surfaces of masks 10 and 60, which are composed of yarns selected for being comfortable to the wearer. Pocket 62 is provided to accept a rectangular filter, e.g., a rectangular version of a filter 84 (discussed with regard to FIG. 18-FIG. 20). However, since pocket 62 encompasses the filter, the filter within pocket 62 does not contact the user's face. Thus, a filter fashioned for pocket 62 may be composed of material that would irritate the wearer's face, e.g., a single-use non-woven filter. For example, a filter for pocket 62 may include a rectangular version of filter 84 without the inner polyester wrap knit layer 91 (FIG. 20) or associated adhesive layer 92 (FIG. 20). Thus, the filter for mask 60 may have the filtering properties of, e.g., layers 93-97 of filter 84 without the expense associated of adding layers 91, 92 to cover layer 93 and prevent it from irritating the wearer. FIG. 13 is a rear right perspective view further illustrating pocket 62 of mask 60 and the different textures of inner layer 64 and outer layer 66.

In embodiments of mask 60, a single “main” knit layer, e.g., inner layer 64 or outer layer 66, may include sub layers of different types of yarns, e.g., of a body, a plating, and a spacer knit.

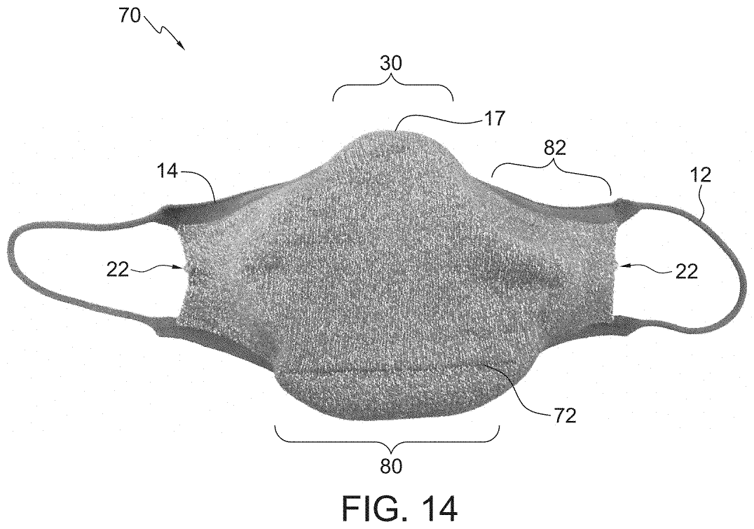

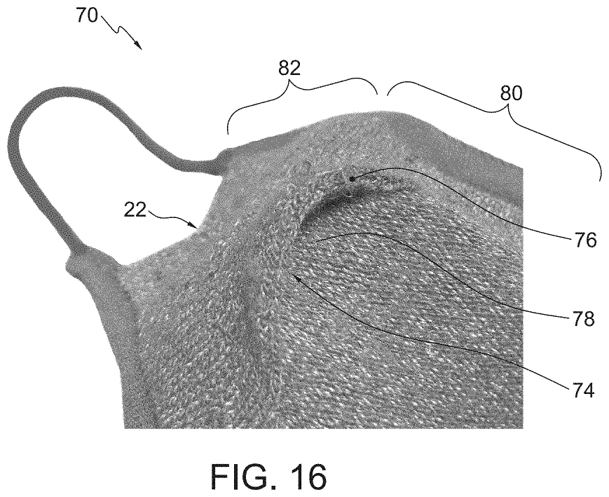

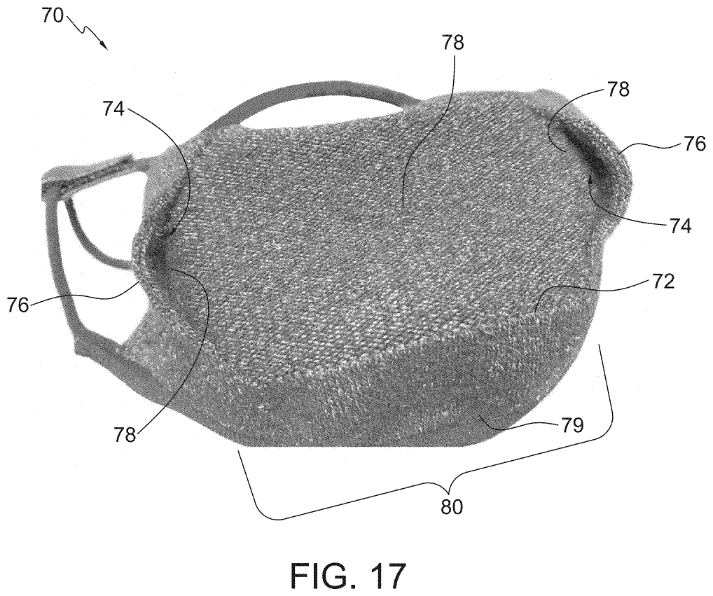

FIG. 14 is a front view of an embodiment of a mask 70. In FIG. 14, the knit texture has been de-emphasized to better illustrate other features of mask 70. Mask 70 includes a facial area 80 and a cheek area 82 that are slightly different from those described with regard to masks 10, 50, and 60. Facial area 80 includes a chin transition line 72, which indicates a transition from a dual-layer 79 (FIG. 16) knit below line 72 to a single layer knit 78 (FIG. 16 and FIG. 17) above line 72.

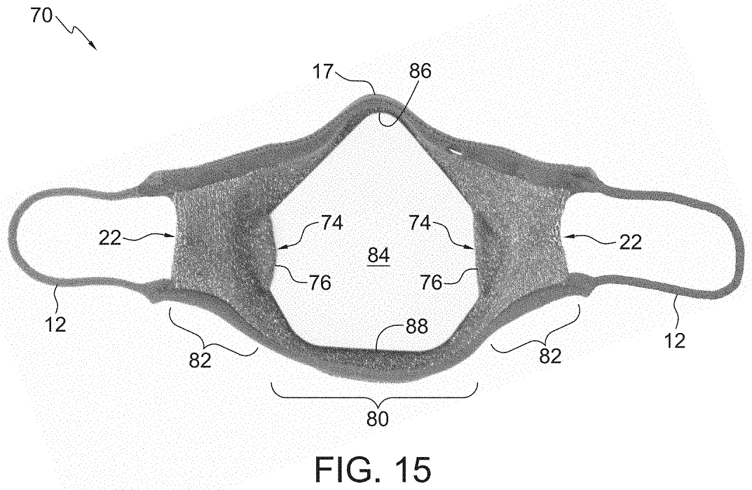

FIG. 15 is a rear perspective view of a detail of the embodiment of mask 70. In FIG. 15, cheek area 82 is shown to include a filter tab retaining pocket (or slot) 74 knit into mask 70. Slot 74 includes an inner layer 76 and an outer layer 78 (the inner surface of single layer of knit material comprising the majority of facial area 80). Filter 84 includes on each side a corner 90 (or a “tab”) that is received by slot 74 and holds filter 84 in place. FIG. 16 is a rear perspective view of the embodiment of mask 70. In FIG. 16, each cheek area 82 is shown to include a slot 74. Also, outer layer 78 is shown to extend from cheek areas 82 and slots 74 through facial area 80. FIG. 16 further illustrates chin transition line 72, above which is single outer layer 78 and below which is dual layer 79. In an embodiment, the dual layer helps provide shaping and rigidity. It also provides a filtration function, as the two layers and the knit structures connecting the two layers have a filtering effect. In an embodiment, a feature of dual layer 79 is that permeability of the dual layer is approximately half the permeability of a single layer to the wearer's breath. The same holds for cheek areas 82. As a result of the relatively larger area of filter 84, the wearer's breath on exhalation flows proportionally more through filter 84. Thus, in the embodiment, the composition of filter 84 largely determines the filtering qualities of mask 70 on the inhalation.

In embodiments, dual-layer 79 may include two knit layers that are separable from each other (or separable between transition line 72 and lower border 14), or dual-layer 79 may include two knit layers that are interconnected by knit structure, which might be created using, e.g., a double-knitting technique. For example, dual-layer 79 may include two distinct knit structures, each with the structure described with regard to Table 1, or dual-layer 79 may include two knit structures, each as described with regard to Table 1, but including additional “tuck” that connect the two knit structures.

FIG. 17 is a top perspective view of the embodiment of mask 70. In FIG. 17, mask 70 shown to include region 30. As with masks 10, 50, and 60, batten 42 (or 40) within region 30 of mask 70 may be deformed to improve the fit of mask 70. FIG. 17 further illustrates that single layer 78 is continuous from left slot 74 (and the corresponding cheek area) to right slot 74 (and the corresponding cheek area).

FIG. 18 is a rear view of the embodiment of mask 70. In FIG. 18, filter 84 is shown to be retained within mask 70 by slots 74. Filter 84 includes a nose 86 that is fashioned to fit within bridge 17. Filter 84 includes a base 88 that is fashioned to fit within the chin area of facial area 80. With filter 84 positioned as shown, when mask 70 is worn, the inner layer of filter 84 may come into contact with the wearer's nose and potentially other facial skin as well. For this reason, filter 84 is adapted to be less irritating to the wearer than, e.g., a typical non-woven filter paper might be. In the embodiment, the single-layer knit region of mask 70 extends between slots 74 and above chin transition line 72—essentially the region covered by filter 84 in FIG. 18 (although filter 84 also covers chin transition line 72 in FIG. 18). Conversely, the dual-layer knit region of mask 70 is outside of the entrances to slots 74 (i.e., inner layer 76 and outer layer 78) and below chin transition line 72.

In embodiments of mask 70, a single “main” knit layer, e.g., inner layer 76 or outer layer 78, may include sub layers of different types of yarns, e.g., of a body, plating, and spacer knit.

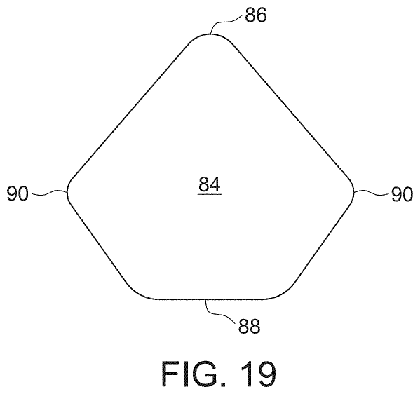

FIG. 19 is a rear view of filter 84. In FIG. 19, filter 84 is shown to include nose 86, chin 88, and tabs 90. FIG. 19 is a rear view in the sense that the surface shown is the surface that would contact the wearer. Filter 84 is dimensioned to cover the majority of the nose, mouth, and chin regions of mask 70, which are mainly single-layer (i.e., the tube section 30 of border 14 is two layer as are cheek regions 82). With mask 70, deformable batten 42 (or 40) may be deformed to make region 30 conform better to the wearer's nose and cheek region, which improves the seal of mask 70 to the wearer both in the nose and cheek region and in the chin region, as discussed earlier. Similarly, darts 22 in cheek areas 82 improve the seal as discussed earlier.

FIG. 20 is an assembly view of filter 84. In FIG. 19, an embodiment of filter 84 includes an inner filter layer 91, two intermediates filter layers 93, 95, and an outer filter layer 97. Layers 91, 93, 95, 97 are joined by adhesive layers 92, 94, 96. In an embodiment of filter 84 employing silvered material, inner layer 91 is a polyester warp knit, which may be a recycled polyester warp knit; intermediate layer 93 is a >99 BFE % Poly-Propylene Non-Woven material; layer 95 is a silvered material, which may be a non-woven filtration layer treated with silver, such as a SilverFlow™ (Bilio LLC) Antimicrobial Non-Woven material; layer 97 is a Fine Gauge Monofilament Spacer Knit material; and layers 92, 94, 96 are a Breathable Non-Woven Adhesive. In an embodiment of filter 84, instead of the silvered material, layer 95 may include a layer that restricts flow relatively less, e.g., a non-woven filtration layer such as AirFlow™ (Bilio LLC). In an embodiment of filter 84, layer 95 may include both silvered material and carbon-containing material, which may be a non-woven filtration layer treated with both silver and carbon, such as a CarbonFlow™ (Bilio LLC). For example, the less restrictive flow filter might be appropriate for environments like classrooms, offices, community spaces where protection and higher breathability are desired. The filter with silvered yarns might be appropriate for higher risk environments like travel, hospital visits, crowded spaces, and unfamiliar indoor environments. And the silver and carbon-containing filter might be appropriate for highest risk environments with smoke, ash, and pollution, such as natural disasters, where filtration is prioritized over breathability.

A feature of the combination of filter 84 and outer layer 78 is that mask 70 may provide filtration approaching or equal to that of an N95 respirator in a sustainable package with partially recycled filter material. The mask thus allows the wearer to have PPE offering protection comparable to the typical N95 mask without diverting the typical N95 mask from, e.g., health care workers.

The previous description has generally discussed the embodiments in terms of a knit construction. However, the description should not be understood to limit the construction of the embodiments to knit material as other materials, such as woven fabric and non-woven materials, may be used instead of a knit to achieve many of the features described regarding masks 10, 50, 60, and 70.

The previous description is provided to enable any person skilled in the art to practice the various aspects described herein. In the embodiments, the separation or orientation of various mask components in the embodiments described above should not be understood as requiring such separation in all embodiments. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims.

What is claimed is:

1. A mask comprising:
a first layer configured to cover a wearer's mouth and nose,
an upper border to the first layer including an internal tube and an access port,
a first ear attachment,
a second ear attachment, and
a batten, wherein:
the batten: is provided within the internal tube; is deformable to adapt the upper border to a wearer's nose; and is removable from the internal tube through the access port.

2. The mask of claim 1, wherein the batten includes an elongate center section terminating at each end in an expanded section.

3. The mask of claim 1 further including a lower border to the first layer, wherein:
the first layer includes a first cheek area, a second cheek area, and a bulbous area;
the bulbous area is surrounded by the upper border, the lower border, the first cheek area, and the second cheek area and the bulbous area extends from the upper border, the lower border, the first check area, and the second cheek area such that, when the mask is worn, the majority of the bulbous area does not contact the wearer.

4. The mask of claim 3, the first cheek area including a first dart and the second cheek area including a second dart, each dart contributing structure to the respective cheek area that inhibits the deformation of the cheek area.

5. The mask of claim 3, wherein the upper border, the lower border, the first cheek area, and the second cheek area cooperate such that, when the mask is affixed to a wearer using the first and second ear attachments, deforming the batten to the adapt the upper border to the wearer's nose increases contact between the upper border and the wearer's nose and cheeks.

6. The mask of claim 5, wherein, when the mask is affixed to a wearer using the first and second ear attachments, deforming the batten to the adapt the upper border to the wearer's nose increases a force of contact of the lower border against the wearer's chin.

7. The mask of claim 6, wherein a force of contact against the wearer's nose and cheeks, and the force of contact to the wearer's chin is increased during a first exhalation in comparison to a second exhalation during which the batten is not adapted to the wearer's nose, such that, when the batten is deformed to adapt to the wearer, relatively less of the wearer's exhalation escapes from between the wearer and the upper border, the lower border, the first cheek region, or the second cheek region.

8. The mask of claim 3, wherein the first layer is a knit first layer and: a first transition from the upper border to the bulbous area, a second transition from the lower border to the bulbous area, a third transition from the first cheek area to the bulbous area, and a fourth transition from the second cheek area to the bulbous area, are knit transitions such that the knit first layer does not contain a sewn seam or cut edge.

9. The mask of claim 8, wherein the knit first layer includes a yarn with a silver component, the silver component providing the knit first layer with enhanced antimicrobial properties.

10. The mask of claim 9, wherein the knit first layer includes an inner surface and an outer surface, the inner surface including more of a first yarn that a second yarn, the outer surface including more of the second yarn than the first yarn, the first yarn being less irritating to a wearer than the second yarn, and the second yarn including the silver component.

11. The mask of claim 3 further including:
a second layer in each of the first cheek area and the second cheek area creating a first slot in the first cheek area and a second slot in the second cheek area; and
a filter including a first tab and a second tab, wherein the filter is configured to cover the majority of the bulbous area and is retained by the first tab being inserted into the first slot and the second tab being inserted into the second slot.

12. The mask of claim 11, wherein:
the second layer in the first cheek area and second cheek area is coextensive with the first layer in the first cheek area and second cheek area; and
a lower section of the bulbous area includes a second layer.

13. The mask of claim 11, wherein the filter includes: an inner filter layer adapted to reduce user irritation; a first intermediate filter layer providing bacterial filtration; a second intermediate filter layer including a non-woven filter material; an outer filter layer including a spacer knit material; and an adhesive layer between each filter layer.

14. The mask of claim 11, wherein the filter includes: an inner filter layer adapted to reduce user irritation; a first intermediate filter layer providing bacterial filtration; a second intermediate filter layer including a silvered yarn; an outer filter layer including a spacer knit material; and an adhesive layer between each filter layer.

15. A kit containing a mask comprising:
a first layer configured to cover a wearer's mouth and nose and including a first cheek area, a second cheek area, and a bulbous area;
a second layer in each of the first cheek area and the second cheek area creating a first slot in the first cheek area and a second slot in the second cheek area;
an upper border to the first layer including an internal tube and an access port,
a first ear attachment,
a second ear attachment,
a plurality of filters, and
a batten, wherein:
the batten: is configured to fit within the internal tube, is deformable to adapt the upper border to a wearer's nose, and is removable from the internal tube through the access port; and
each filter of the plurality of filters: includes a first tab and a second tab, is configured to cover the majority of the bulbous area, and is retained by the first tab being inserted into the first slot and the second tab being inserted into the second slot.

16. The mask of claim 15, wherein the upper border, the lower border, the first cheek area, and the second cheek area cooperate such that, when the mask is affixed to a wearer using the first and second ear attachments, deforming the batten to the adapt the upper border to the wearer's nose increases the contact of the upper border to the wearer's nose and cheeks.

17. The mask of claim 16, wherein, when the mask is affixed to a wearer using the first and second ear attachments, deforming the batten to the adapt the upper border to the wearer's nose increases the contact of the lower border to the wearer's chin.

18. The mask of claim 15, wherein:
the second layer in the first cheek area and second cheek area is coextensive with the first layer in the first cheek area and second cheek area; and
a lower section of the bulbous area includes a second layer.

19. The mask of claim 16, wherein:
a first filter of the plurality includes: an inner filter layer adapted to reduce user irritation; a first intermediate filter layer providing bacterial filtration; a second intermediate filter layer including a non-woven filter material; an outer filter layer including a spacer knit material; and an adhesive layer between each filter layer;
a second filter of the plurality includes the filter layers of the first filter except the second intermediate filter layer includes a silvered yarn; and
a third filter of the plurality include the filter layers of the second filter except the second intermediate filter layer further includes a carbon-containing material.

20. A mask comprising:
a knit first layer configured to cover a wearer's mouth and nose and including
an inner surface and an outer surface, the inner surface including more of a first yarn that a second yarn, the outer surface including more of the second yarn than the first yarn, the first yarn being less irritating to a wearer than the second yarn, and the second yarn including a silver component;
a knit upper border to the first layer including an internal tube and an access port;
a knit lower border to the first layer;
a first ear attachment;
a second ear attachment; and
a batten; wherein:
the batten is provided within the internal tube, is deformable to adapt the upper border to a wearer's nose, and is removable from the internal tube through the access port;
the first layer includes a first cheek area, a second cheek area, and a bulbous area;
the bulbous area is surrounded by the upper border, the lower border, the first cheek area, and the second cheek area and the bulbous area extends from the upper border, the lower border, the first check area, and the second cheek area such that, when the mask is worn, the majority of the bulbous area does not contact the wearer; and
a first transition from the upper border to the bulbous area, a second transition from the lower border to the bulbous area, a third transition from the first cheek area to the bulbous area, and a fourth transition from the second cheek area to the bulbous area, are knit transitions such that the knit first layer does not contain a sewn seam or cut edge.
